(19) United States
(12) Patent Application Publication
(10) Pub. No.: US 2022/0395870 A1
(43) Pub. Date: Dec. 15, 2022

(54) BEAKER CLEANING RECOVERY OVEN FOR USE IN A CANNABIS OIL EXTRACTION PROCESS AND METHODS OF USE

(71) Applicant: Derek Hudspeth, Huntsville, AR (US)

(72) Inventor: Derek Hudspeth, Huntsville, AR (US)

(21) Appl. No.: 17/527,244

(22) Filed: Nov. 16, 2021

Related U.S. Application Data
(60) Provisional application No. 63/208,994, filed on Jun. 10, 2021.

(51) Int. Cl. B08B 7/00; B08B 9/08; B08B 9/40; B08B 9/42

(52) U.S. Cl. CPC B08B 7/0071; B08B 9/0826; B08B 9/40; B08B 9/423; B08B 9/426

(57) ABSTRACT

A beaker cleaning recovery oven for extracting cannabis oil from a beaker including an oven, a beaker stand placed in the oven, and a beaker placed over the beaker stand. The beaker has a film or residue of cannabis after it being used for cannabis extraction process, rinsed with ethanol and drained for a predetermined time period. The oven heats and brings up the heat inside the beaker. The beaker stand rotates allowing the beaker to heat up evenly. The beaker heats up the film or residue of cannabis to flow down as cannabis oil. The oven positions over a cart allowing it to be transported. The cart includes a base frame with cut-sections for holding the beaker when not in use. The beaker cleaning recovery oven helps to reclaim a substantial amount of the film or residue from the beaker used during an extraction process.

### CROSS-REFERENCE TO RELATED APPLICATIONS

This present application claims priority from U.S. Provisional Patent Application Ser. No. 63/208,994, filed on Jun. 10, 2021, which is incorporated herein by its entirety and referenced thereto.

### FIELD OF INVENTION

The present invention generally relates to extraction techniques. More specifically, the present subject invention relates to a beaker cleaning recovery oven and a method of extracting cannabis oil.

### BACKGROUND OF INVENTION

The cannabis plant constituents a variety of potentially valuable compounds. The compounds include cannabidiol (CBD), tetrahydrocannabinol (THC), cannabichromene (CBC), cannabinol (CBN), cannabigerol (CBG), and other compounds in varying amounts. The cannabinoids provide numerous therapeutic benefits and are used to treat a variety of diseases and conditions for centuries. For example, cannabinoids are used to treat insomnia, chronic pain, insufficient appetite associated with anorexia or HIV/AIDS, glaucoma, arthritis, nausea arising from chemotherapy, and post-traumatic stress disorder, among others.

Typically, the cannabinoids are extracted from the cannabis plant to harness their medicinal properties. The extracted oil is refined to isolate particular cannabinoids or blends of cannabinoids for desired uses. A solvent or non-solvent based extraction technique is employed to extract cannabis oil from cannabis plant.

Several techniques have been disclosed in the past for extracting cannabis oil from the cannabis plant. One such example is disclosed in a United States granted Patent no. 9,155,767, entitled “Essential element management” (“the '767 Patent”). The '767 Patent discloses extraction of medicinal cannabis compounds into an eluate, by separating a portion of medicinal cannabis compounds contained within a portion of eluate at a first extraction target level, to provide enough clean solvent to continue extraction operations. A high efficiency concentrator such as a rotary evaporator or a wiped film evaporator processes eluate from one or more tanks or extraction vessels creating clean solvent when extraction targets are met or when clean solvent is exhausted. This manages eluate concentration levels and limits the quantity of concentrated medicinal cannabis compounds on site at any moment in time.

Although the above discussed patent and other disclosures disclose several techniques for extracting cannabis oil, they have few problems. For instance, the constituents/residue of cannabis get stuck to the apparatuses used during the extraction or cleaning process. This results in wastage of the cannabis and potential loss of profit for the producers. It would be beneficial to maximize the extraction of the cannabis oil without minimum or no wastage.

Therefore, there is a need in the art to provide an improved process or technique for extracting cannabis oil without any wastage.

### SUMMARY OF THE INVENTION

It is an object of the present subject matter to provide an improved process or technique for extracting cannabis oil and that avoids the drawback of known techniques.

It is another object of the present subject matter to provide a beaker cleaning recovery oven that reclaims a substantial amount of the film or residue from a beaker used during an extraction process.

It is another object of the present subject matter to provide a beaker cleaning recovery oven that helps to extract the cannabis oil from a beaker and reduces waste.

In order to achieve one or more objects here stated, the present invention provides a beaker cleaning recovery oven for extracting cannabis oil. The beaker cleaning recovery oven includes an oven, a beaker stand placed in the oven and a beaker connecting the beaker stand. The beaker includes a neck and is positioned upside down facing the beaker stand. Generally, during the extraction process of the cannabis oil, the apparatus used for extraction pulls a vacuum on the cannabis. The process includes rinsing/cleaning the apparatus with a cleaning agent such as ethanol, all of which goes into a beaker. In the present invention, when the beaker is full, the contents in the beaker (from the prior process) is dumped out and the beaker is drained for a few minutes. After draining, the beaker is cradled in the oven for heating the beaker to reclaim the cannabis. The oven brings the temperature of the beaker i.e., heats the beaker through the neck. The beaker stand rotates and allows the beaker to heat evenly. As the process continues, the oil begins to flow and drains out of the beaker and is collected in a catch pan placed under and outer area of the oven. This reclaims a substantial amount of film or residue of cannabis that was in the beaker from the prior extraction process. In one example, the beaker cleaning recovery oven helps to reclaim about 70 to 90% of the film or residue of cannabis that was in the beaker from the prior extraction process.

The beaker cleaning recovery oven further includes a cart. The oven positions over the cart for easy transportation. The cart includes a base frame with cut-sections. The beaker that is either unused or rinsed with the cleaning agent from prior process is placed at the cut-sections. This helps the beaker to drain before it is ready for use. The cart includes rails for preventing the beaker from any external impact. The cart or the oven includes a housing having a display for displaying the temperature of the oven and/or the beaker.

In one advantageous feature of the present subject matter, the beaker cleaning recovery oven allows to extract/recover/reclaim a substantial amount of the film or residue of the cannabis that was in the beaker from previous extraction process. The beaker cleaning recovery oven helps to reduce and/or utilise the waste from previous extraction process to increase cannabis extraction and increase profitability. The reclaiming/recovery process further reduces the labour needed to extract the residue of cannabis in conventional ways with heat guns and manpower, for example.

In another advantageous feature of the present subject matter, the cart holds the extra beakers when not in use. The rails at the cart protect the beakers from any impact. This prolongs the life of the beaker and its usage.

Features and advantages of the subject matter hereof will become more apparent considering the following detailed description of selected embodiments, as illustrated in the accompanying FIGUREs. As will be realised, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

Further features and advantages of the present subject matter will become apparent from the following detailed description, taken in combination with the appended drawings, in which:

FIG. 1 illustrates an environment in which a beaker cleaning recovery oven implements, in accordance with one exemplary embodiment of the present invention;

FIGS. 2A and 2A illustrate a front perspective view and a side perspective view, respectively of a cart of the beaker cleaning recovery oven, in accordance with one embodiment of the present invention;

FIG. 3 illustrates a block diagram of electronic components in a housing, in accordance with one embodiment of the present invention;

FIG. 4 illustrates a front side perspective view of a container, in accordance with one embodiment of the invention;

FIG. 5 illustrates a bottom perspective view of an exhaust opening at a top wall of the container, in accordance with one embodiment of the invention;

FIGS. 6 and 7 illustrate perspective views of the container surrounded by heat insulation layers, in accordance with one embodiment of the invention;

FIG. 8 illustrates a perspective view of an oven, in accordance with one embodiment of the invention;

FIG. 9 illustrates a perspective view of a beaker assembly in the container, in accordance with one embodiment of the invention;

FIG. 10 illustrates a top view of a beaker stand having teeth, in accordance with one embodiment of the invention; and

FIG. 11 illustrates the teeth engaged by a gear member with the help of a motor, in accordance with one embodiment of the invention.

It will be noted that throughout the appended drawings, like features are identified by like reference numerals.

### DETAILED DESCRIPTION OF THE EMBODIMENTS

Before the present features and working principle of a beaker cleaning recovery oven is described, it is to be understood that this subject matter is not limited to the particular device as described, since it may vary within the specification indicated. Various features of the beaker cleaning recovery oven might be provided by introducing variations within the components/subcomponents disclosed herein. It is also to be understood that the terminology used in the description is for the purpose of describing the particular versions or embodiments only, and is not intended to limit the scope of the present subject matter, which will be limited only by the appended claims. The words “comprising,” “having,” “containing,” and “including,” and other forms thereof, are intended to be equivalent in meaning and be open-ended in that an item or items following any one of these words is not meant to be an exhaustive listing of such item or items, or meant to be limited to only the listed item or items.

It should be understood that the present subject matter describes a beaker cleaning recovery oven for extracting cannabis oil from a beaker. The beaker cleaning recovery oven includes an oven, and a beaker stand placed in the oven. The beaker cleaning recovery oven includes a beaker placed over the beaker stand. The beaker has a film or residue of cannabis after it being used for cannabis extraction process, rinsed with ethanol and drained for a predetermined time period. The oven heats and brings up the heat inside the beaker. The beaker stand rotates allowing the beaker to heat up evenly. The beaker heats up allowing the film or residue of cannabis to become less viscous and flow down the beaker as cannabis oil. In one embodiment, the oven positions over a cart allowing it to be transported. The cart includes a base frame with cut-sections for holding the beaker when not in use. The beaker cleaning recovery oven helps to reclaim a substantial amount of the film or residue that was in the beaker from previous extraction process and reduces waste.

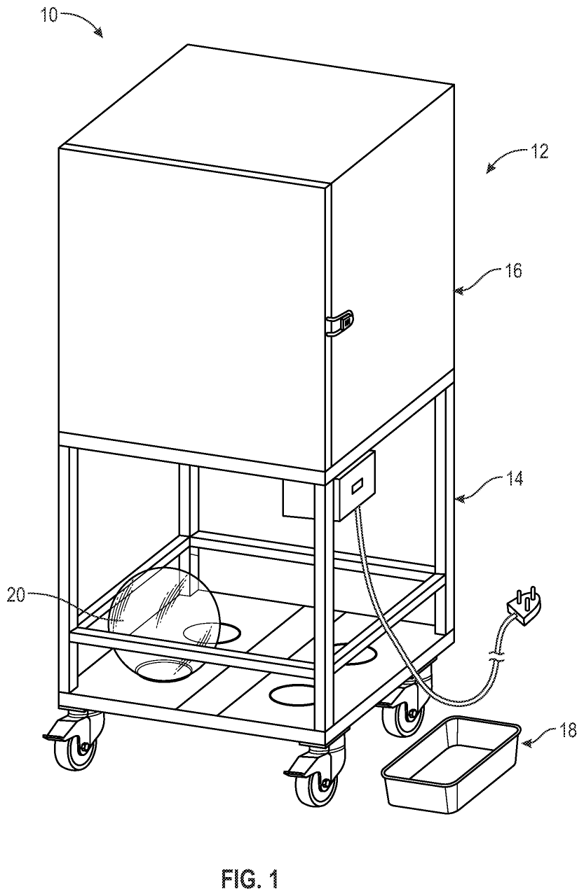

Various features and embodiments of the beaker cleaning recovery oven for extracting cannabis oil are explained in conjunction with the description of FIGS. 1-11.

FIG. 1 shows an environment 10 in which beaker cleaning recovery oven 12 implements, in accordance with one exemplary embodiment of the present invention. Beaker cleaning recovery oven 12 includes cart 14 and oven 16. Here, cart 14 acts as a base section or base station for moving around oven 16 from one place to another depending on the need. Beaker cleaning recovery oven 12 includes catch pan 18 for collecting the extracted cannabis oil using beaker cleaning recovery oven 12. Further, beaker cleaning recovery oven 12 includes one or more empty beakers 20 placed at cart 14 when not in use. When needed, beaker 20 is placed or cradled in oven 16 for extracting cannabis oil.

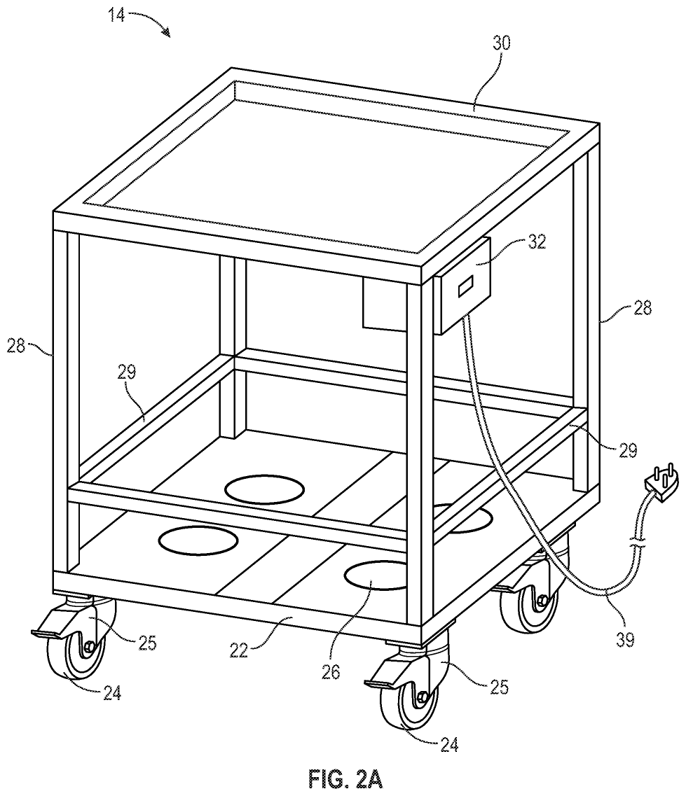

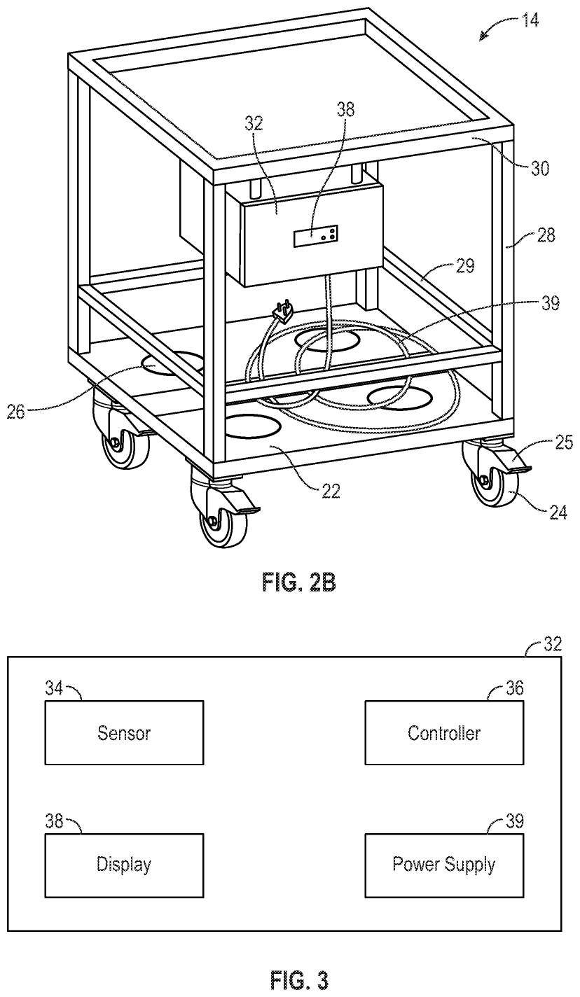

FIGS. 2A and 2B show a front perspective view and a side perspective view, respectively of cart 14, in accordance with one embodiment of the present invention. Cart 14 presents base frame 22. Base frame 22 provides a material made of metal, plastic, wood or any other suitable material. Base frame 22 comes in a square, rectangular or any other shape. Base frame 22 includes wheels 24 connected by casters 25. Wheels 24 help to move around cart 14 from one place to another. In one example, base frame 22 encompasses one or more cut-sections 26. Cut-sections 26 receive empty beakers 20 when they are not in use. Further, cut-sections 26 help to position beakers 20 facing downwards for drying or draining up the interior of beakers 20, as shown in FIG. 1, for example. Cart 14 includes legs 28 extending from the corners of base frame 22. In one embodiment, legs 28 provide rails 29 positioning parallel to base frame 22. Rails 29 position at suitable length across legs 28 and prevent beakers 20 placed at base frame 22 from falling or any external impact. At the top, legs 28 include oven receiving section 30. Oven receiving section 30 comes in the shape of step-like structure such that oven 16 remains in position when oven 16 is placed over cart 14 as shown in FIG. 1, for example.

In one embodiment, cart 14 includes housing 32 at oven receiving section 30. Housing 32 sUS0ends from oven receiving section 30, as shown in FIG. 2B, for example. Housing 32 encompasses electrical components needed to operate beaker cleaning recovery oven 12.

FIG. 3 shows a block diagram of housing 32, in accordance with one embodiment of the present invention. Housing 32 includes sensor 34. Sensor 34 includes a temperature sensor or any other sensor depending on the need. Housing 32 includes controller 36. Controller 36 includes any suitable processing device, such as a microprocessor, a microcontroller, an integrated circuit, a logic device, or other suitable processing device. Further, housing 32 presents display 38. Display 38 electrically connects to controller 36. Controller 36 fetches the temperature sensed by sensor 34 and displays the values at display 38. Housing 32 further includes power supply/cable 39 providing power via a power source such as AC/DC or battery.

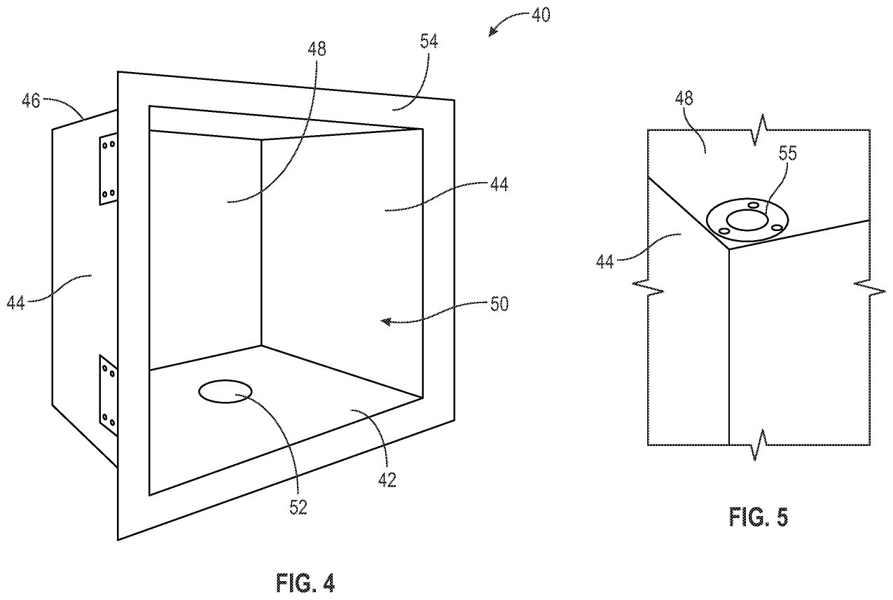

Oven 16 includes container 40. FIG. 4 shows a front side perspective view of container 40, in accordance with one embodiment of the present invention. Container 40 provides a material made of metal or any other suitable material that can withstand the heat during the extraction of the cannabis oil. Container 40 presents base 42, sidewalls 44, top wall 46, and rear wall 48. Base 42, sidewalls 44, top wall 46 and rear wall 48 provide opening 50 at the front. Opening 50 provides access to interior of container 40. Base 42 encompasses hole 52. Further, container 40 includes flanges 54 extending outwardly from the edges of base 42, sidewalls 44, and top wall 46. In one exemplary embodiment, top wall 46 encompasses exhaust opening 55 at one corner for dispensing excess heat from container 40 during use. FIG. 5 shows the feature of top wall 46 encompassing exhaust opening 55.

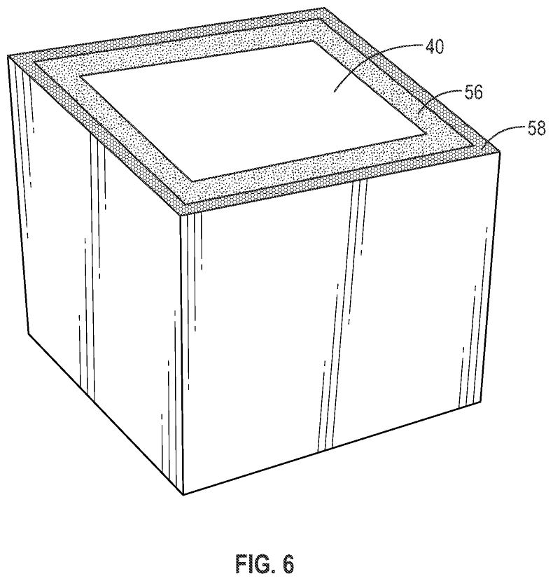

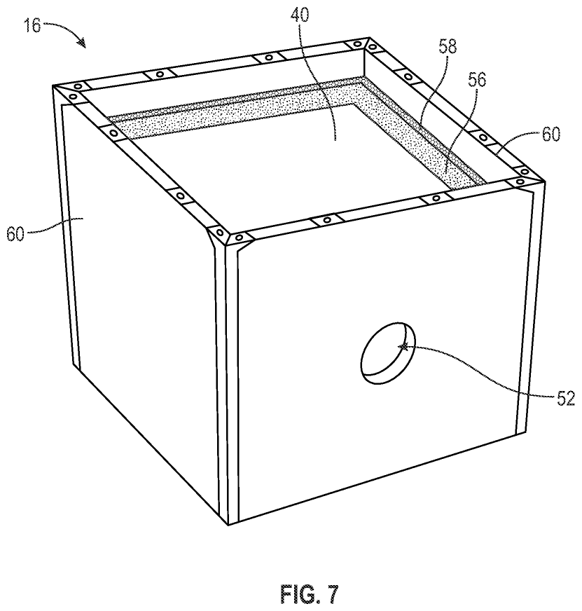

As presented above, container 40 provides a material made of metal or any other suitable material that can withstand the heat during the extraction of the cannabis oil. The heat inside the container gets transferred to its outside walls. To dissipate the heat and ensure a user does not encounter the heat, container 40 is surrounded by multiple heat insulation layers. In the present invention, container 40 surrounds with two or more insulation layers. In one example, container 40 surrounds with three insulation layers i.e., first insulation layer 56, second insulation layer 58 and third insulation layer 60. First insulation layer 56 includes a mineral wool, for example. Second insulation layer 58 includes a ceramic fiber blanket, for example. Third insulation layer 60 includes, but not limited to, material made of metal, plastic, etc. A person skilled in the art understands that any number of layers can be used with a variety of materials to provide proper heat insulation for oven 14 without departing from the scope of the present invention. FIG. 6 shows the feature of container 40 surrounded by first insulation layer 56 and second insulation layer 58. FIG. 7 shows the feature of container 40 surrounded by first insulation layer 56, second insulation layer 58 and third insulation layer 60.

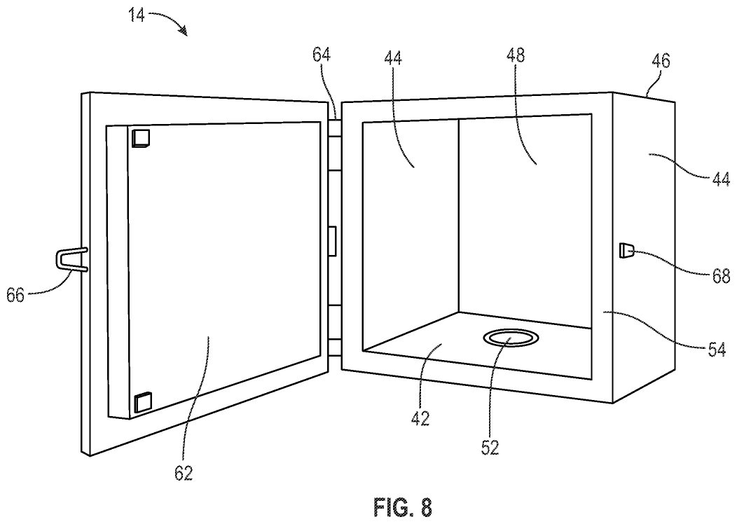

Further, oven 16 includes door 62, as shown in FIG. 8. In the present invention, door 62 includes all the insulation layers of protection similar to container 40, as presented above. Door 62 connects to container 40 at flanges 54 via hinges 64. Door 62 provides access to interior of container 40. Door 62 encompasses male member 66. Male member 66 connects to female member 68 positioned at outer side of side wall 44 of container 40 thereby forming a closed structure of oven 16.

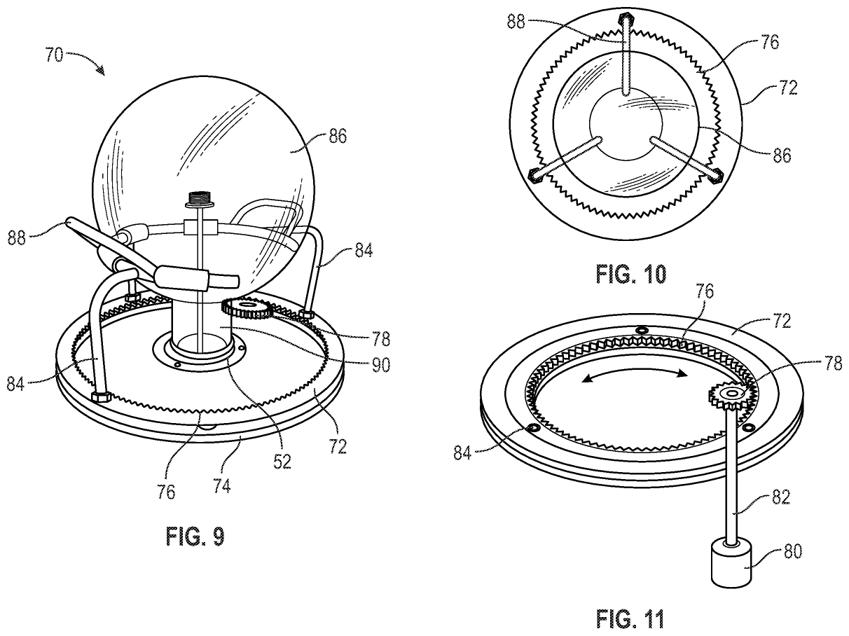

Oven 16 receives beaker assembly 70 in container 40 for extracting cannabis oil from beaker 20, 86. FIG. 9 shows the feature of beaker assembly 70 placed at base 42 of container 40. Beaker assembly 70 includes beaker stand 72. Beaker stand 72 positions over support rim 74 placed at base 42. Support rim 74 comes in the shape of beaker stand 72 and helps in rotation of beaker stand 72 over it. This allows beaker stand 72 and components (such as beaker 86) placed over it to rotate. Beaker stand 72 encompasses teeth 76 at its inner circumference. FIG. 10 shows the feature of beaker stand 72 having teeth 76 at its inner circumference, in accordance with one embodiment of the present invention. Beaker assembly 70 includes gear member 78 connecting beaker stand 72 at its teeth 76. Here, gear member 78 is smaller in size compared to beaker stand 72. Beaker stand 72 with teeth 76 acts as a stationary gear and smaller gear member 78 rotates along teeth 76. To operate the smaller gear member 78, motor 80 is used. Motor 80 has shaft 82 delivering required power to rotate gear member 78 along teeth 76 at beaker stand 72. FIG. 11 shows the feature of gear member 78 connecting motor 80 via shaft 82, in accordance with one embodiment of the present invention. In one example, power supply 39 supplies power required to operate motor 80 which in turn operates gear member 78.

Further, beaker stand 72 includes extending arms 84. Extending arms 84 extend from beaker stand 72 and receive beaker 86 (similar to beaker 20), as shown in FIG. 9. In one example, extending arms 84 present handles 88 for aiding in placement of beaker assembly 70. Beaker 86 provides a transparent container with neck 90 having an opening. In one example, 18″ beaker 20 is selected for extracting cannabis oil. However, a person skilled in the art understands beaker 86 can come in different shapes and sizes without departing from the scope of the present invention. In the present invention, beaker 86 is positioned upside down such that neck 90 aligns and faces hole 52 at base 42 of container 40. Further, beaker 86 encompasses a tube (not shown). The tube extends from beaker 86 and connects to catch pan 18 placed at the side of beaker cleaning recovery oven 12, as shown in FIG. 1.

The presently disclosed beaker cleaning recovery oven 12 aids in reclaiming a substantial amount of the film or residue of cannabis that is left in beaker 86 after it has been used for extracting cannabis oil prior. In one example, the presently disclosed beaker cleaning recovery oven 12 aids in reclaiming 70 to 90% of the film or residue of cannabis that is left in beaker 86 after it has been used for extracting cannabis oil prior. It should be understood that the percentage of film or residue reclaimed varies depending on the cleaning of the beaker, amount of cannabis actually remained in the beaker after it has been used for extracting cannabis oil prior among other factors. At first, cannabis oil is extracted using any conventional extraction process. During the extraction process, vacuum on the cannabis is pulled. Subsequently, a cleaning agent such as ethanol is used to rinse the remains of cannabis in beaker 86. Further, beaker 86 is emptied and placed upside down (as shown in FIG. 1) for a predetermined time period, say for few minutes. Here, beaker 86 drains out leaving a thin film or residue of cannabis from earlier extraction process.

After draining, beaker 86 is placed in oven 16 where neck 90 faces down, as shown in FIG. 9. As specified above, beaker 86 is connected to beaker assembly 70 inside container 40 and door 62 is closed. Oven 16 is powered ON using power supply 39 for increasing the temperature of container 40. Increasing the temperature inside container 40 brings up the temperature of beaker 86. As presented above, beaker 86 rests over beaker stand 72 in which neck 90 faces down. As beaker stand 72 rotates, beaker 86 rotates in turn and heats up evenly. Here, the temperature of container 40 and/or beaker 86 is monitored at display 38. As the temperature of beaker 86 goes up, the residual particles of the cannabis at the inner walls of beaker 86 heats up and becomes less viscous forming cannabis oil. Due to the placement (upside down of beaker 86), the cannabis oil begins to flow down and drains out of beaker 86. Here, the tube receives and delivers the cannabis oil into catch pan 18 placed outside of beaker cleaning recovery oven 12.

The above process allows to reclaim a substantial amount of the film or residue of cannabis that was in beaker 86 from previous extraction process. The presently disclosed beaker cleaning recovery oven allows to extract/recover/reclaim cannabis oil from residue and helps to reduce waste and increase profitability. The reclaiming/recovery process further reduces the labour needed to extract the residue in conventional ways with heat guns and manpower, for example.

Although the above description is explained considering that the beaker cleaning recovery oven includes the oven placed over the cart, it is possible to utilise only the oven to extract the cannabis oil from residue of previous extraction process. In such an implementation, the oven is placed over a surface such as a ground or a table without the need for the cart or stand. However, it is preferable to use the cart as it helps to transport the oven from one place to another. Further, the cart provides the cut-sections for holding extra beakers when not in use. Further, the cart can be used to dry or drain one or more beakers before they are used for extracting the cannabis oil from the residue of previous extraction process. The cart encompasses rails around the legs to protect the beakers from any impact.

In the above description, numerous specific details are set forth such as examples of some embodiments, specific components, devices, methods, to provide a thorough understanding of embodiments of the present disclosure. It will be apparent to a person of ordinary skill in the art that these specific details need not be employed, and should not be construed to limit the scope of the disclosure.

In the development of any actual implementation, numerous implementation-specific decisions must be made to achieve the developer's specific goals, such as compliance with system-related and business-related constraints. Such a development effort might be complex and time consuming, but may nevertheless be a routine undertaking of design, fabrication, and manufacture for those of ordinary skill. Hence as various changes could be made in the above constructions without departing from the scope of the invention, it is intended that all matter contained in the above description or shown in the accompanying drawings shall be interpreted as illustrative and not in a limiting sense.

The foregoing description of embodiments is provided to enable any person skilled in the art to make and use the subject matter. Various modifications to these embodiments will be readily apparent to those skilled in the art, and the novel principles and subject matter disclosed herein may be applied to other embodiments without the use of the innovative faculty. The claimed subject matter set forth in the claims may not intended to be limited to the embodiments shown herein, but is to be accorded the widest scope consistent with the principles and novel features disclosed herein. It is contemplated that additional embodiments are within the spirit and true scope of the disclosed subject matter.

What is claimed is:

1. A beaker cleaning recovery oven, comprising:
an oven;
a beaker stand placed in said oven; and
a beaker cradled in said beaker stand, wherein said beaker has a film or residue of cannabis upon it being used for cannabis extraction process, rinsed with a cleaning agent and drained for a predetermined time period,
wherein said oven heats and brings up the heat inside said beaker, wherein said beaker stand rotates allowing said beaker to heat up evenly, and wherein said beaker heats up allowing the film or residue of cannabis to become less viscous and flow down said beaker as cannabis oil for reclaiming the film or residue of cannabis.

2. The beaker cleaning recovery oven of claim 1, wherein said oven comprises a container.

3. The beaker cleaning recovery oven of claim 2, wherein said container surrounds by heat insulation layers.

4. The beaker cleaning recovery oven of claim 1, wherein said beaker stand comprises teeth at its inner circumference.

5. The beaker cleaning recovery oven of claim 4, wherein said teeth are engaged by a smaller gear member.

6. The beaker cleaning recovery oven of claim 5, wherein said gear member is powered by a motor.

7. The beaker cleaning recovery oven of claim 1, further comprises a catch pan outside of said oven for collecting the cannabis oil.

8. The beaker cleaning recovery oven of claim 1, wherein said beaker connects to said beaker stand via extending arms.

9. The beaker cleaning recovery oven of claim 1, wherein said oven comprises a door providing access to interior of said oven.

10. The beaker cleaning recovery oven of claim 1, further comprises a cart, wherein said oven is placed over said cart.

11. The beaker cleaning recovery oven of claim 10, wherein said cart comprises a base frame having cut-sections, and wherein said cut-sections receive said beaker when not in use and allows for draining said beaker.

12. The beaker cleaning recovery oven of claim 11, wherein said cart comprises rails for preventing said beaker from an impact.

13. The beaker cleaning recovery oven of claim 10, wherein said cart comprises wheels for transporting said beaker cleaning recovery oven.

14. The beaker cleaning recovery oven of claim 1, further comprises a housing having a display for displaying the temperature of said oven and/or said beaker.

15. A beaker cleaning recovery oven, comprising:
an oven placed over a cart, wherein said oven comprises a hole at the bottom facing said cart;
a beaker stand placed in said oven, wherein said beaker stand comprises extending arms;
a beaker comprising a neck with an opening,
wherein said beaker connects to said extending arms in which said neck aligns with said hole in said oven, wherein said beaker has a film or residue of cannabis upon it being used for cannabis extraction process, rinsed with a cleaning agent and drained for a predetermined time period; and
a catch pan outside of said oven,
wherein said oven heats and brings up the heat inside said beaker, wherein said beaker stand rotates allowing said beaker to heat up evenly, wherein the heat inside said beaker allows the film or residue of cannabis to flow down said neck as cannabis oil, and wherein the cannabis oil gets collected in said catch pan.

16. The beaker cleaning recovery oven of claim 15, said oven comprises a container surrounded by heat insulation layers.

17. The beaker cleaning recovery oven of claim 15, wherein said cart comprises a base frame having cut-sections, and wherein said cut-sections receive said beaker when not in use and allows for draining said beaker.

18. The beaker cleaning recovery oven of claim 15, wherein said cart comprises rails for preventing said beaker from an impact.

19. The beaker cleaning recovery oven of claim 15, wherein said cart comprises wheels for transporting said beaker cleaning recovery oven.

20. A method of providing a beaker cleaning recovery oven for extracting residue of cannabis oil from a beaker, said method comprising the steps of:
providing an oven;
providing a beaker stand placed in said oven;
providing a beaker over said beaker stand, said beaker comprising a film or residue of cannabis upon it being used for cannabis extraction process, rinsed with a cleaning agent and drained for a predetermined time period;
increasing the temperature of said oven for bringing up the heat inside said beaker;
rotating said beaker stand for heating up said beaker evenly;
allowing said film or residue of cannabis to heat up and flow down as cannabis oil; and
collecting said cannabis oil.
